(19) United States
(12) Patent Application Publication
(10) Pub. No.: US 2010/0264668 A1
(43) Pub. Date: Oct. 21, 2010

(54) Micro electromechanical generator and method of converting mechanical centrifugal energy into electrical energy

(76) Inventor: Anthony Shane Hughes, SR., Chesterfield, MI (US)

Correspondence Address: Anthony Shane Hughes Sr., 51291 Village Edge East, Apt. 44-302, New Baltimore, MI, 48047, US

(21) Appl. No.: 12/426,936

(22) Filed: Apr. 20, 2009

(51) Int. Cl. F03G 7/08

(52) U.S. Cl. 290/1 C

(57) ABSTRACT

A device for converting mechanical centrifugal energy into electrical energy. This invention having a weighted gear that spins around a shaft and engages a torque increasing gear train to wind a spring. The force of the wound spring is unleashed by means of a clutch and switch assembly and thus engages a second gear train that increases speed and is connected to the shaft of a DC motor through a series of gears. The DC motor sends the created electrical energy to a first circuit board assembly that increases the electrical energy output and transfers the increased electrical energy to a capacitor where the electrical energy is stored. There is a second circuit board assembly, which takes the overflow of the electrical energy that is stored within the capacitor and transfers the electrical to a rechargeable battery that is encased within the master assembly thus providing a charge to the said battery. A third circuit board assembly takes the stored energy from the rechargeable battery and regulates the electrical energy flow to the Positive and Negative connection to regulate the energy flow to the master battery assembly's specifications.

### CROSS-REFERENCE TO RELATED APPLICATIONS

| | | |
|---|---|---|
| 7,453,163 | Nov. 18, 2008 | Roberts, et al. |
| 3,596,262 | July 1971 | Rollwitz et al. |
| 4,642,547 | February 1987 | Redlich |
| 4,950,931 | August 1990 | Goldenberg et al. |
| 5,016,055 | May 1991 | Pietrowski et al. |
| 5,023,526 | June 1991 | Kuwabara et al. |
| 5,347,186 | September 1994 | Konotchick |
| 5,510,660 | April 1996 | Flatau et al. |
| 6,232,689 | May 2001 | Fujita et al. |
| 6,984,902 | January 2006 | Huang et al. |
| 7,112,911 | September 2006 | Tanaka et al. |
| 7,345,372 | March 2008 | Roberts et al. |
| 7,127,886 | October 2006 | Fielder |
| 6,814,483 | Nov. 9, 2004 | Watanabe, et al. |
| 3,901,019 | August 1975 | Kocher et al. |
| 4,213,293 | July 1980 | Mabuchi et al. |
| 4,500,213 | February 1985 | Grimm |
| 5,867,454 | February 1999 | Takahashi et al. |
| 6,441,516 | August 2002 | Kaelin et al. |
| 6,485,172 | November 2002 | Takahashi et al. |

### STATEMENT REGARDING FEDERALLY SPONSORED RESEARCH OR DEVELOPMENT

This is not in any way Federally Sponsored. I am an Independent Inventor claiming small entity.

### REFERENCE TO SEQUENCE LISTING, A TABLE, OR A COMPUTER PROGRAM LISTING COMPACT DISC APPENDIX

There are no computer programs involved.

### BACKGROUND OF THE INVENTION

1. Technical Field

A micro electromechanical generator, which is comprised of an electromechanical device for converting mechanical centrifugal energy into electrical energy. This electromechanical device having a weighted gear that spins around a shaft and engages a torque increasing gear train to wind a spring. The force of the wound spring is unleashed by means of a clutch and switch assembly and thus engages a second gear train that increases speed and is connected to the shaft of a DC motor through a series of gears. The DC motor sends the created electrical energy to a first circuit board assembly that increases the electrical energy output and transfers the increased electrical energy to a capacitor where the electrical energy is stored. There is a second circuit board assembly, which takes the overflow of the electrical energy that is stored within the capacitor and transfers the electrical to a rechargeable battery that is encased within the master assembly thus providing a charge to the said battery. A third circuit board assembly then takes the stored energy from the rechargeable battery and regulates the electrical energy flow to the Positive and Negative connection ends to regulate the energy flow to the master battery assemblies to set within the master battery's specifications.

2. Description of Prior Art

There has been great advancement in the field of rechargeable batteries throughout the world today. But as technology in electronics increases, the demand for mobile power is also increasing.

There is a form of self-powered energy and may be practical in terms of It's application to mobile devices. As motion-based electromagnetic fields produce power, energy is converted into electricity; in other words, your movements throughout the day can charge your mobile phone for a certain period of time. There has also been advancement in Micro Electrical Mechanical Systems (MEMS) these such devices are described as being used for energy harvesting. The above-mentioned devices are being investigated for powering wireless sensors.

### BRIEF SUMMARY OF THE INVENTION

In my present invention, my idea is to charge a rechargeable battery seated within my battery assembly by utilizing mechanical centrifugal energy to convert to electrical energy. There have been similar methods used in the past for automatic self-winding watches. My idea is different such as the winding mechanism is used to wind a coil spring through a clutch. Then on the other end of the clutch, a switch transfers the mechanical force in the coil spring to a second gear train that spins the shaft of a dc motor.

The power generated from the Positive and Negative wire from the DC motor is then transferred to a circuit board assembly that contains a dc voltage amplifier circuit. The amplified electricity is then transferred to a Capacitor. The energy is then transferred from the capacitor to a second circuit board assembly that sends the above energy to a rechargeable battery within the assembly.

The energy is then sent from the rechargeable battery to a third circuit board assembly that controls the energy flow to coincide with the outer battery specifications.

The constituting elements of the present invention can be assembled into a casing so that it can be used almost permanently without separate recharge although the assembly can be connected to a battery charger if a faster charge is required.

The battery assembly of the present invention is provided as one battery assembly, which can be used at any application such as a Military personnel, toys, cell phones, medical uses and prosthetics or pace makers.

The present design can be used in any size battery.

### BRIEF DESCRIPTION OF THE SEVERAL VIEWS OF THE DRAWING

Brief description of the present invention will now be described by example with reference to the accompanying drawings in that which,

FIG. 1 is a flow chart that shows the entire operation of my present invention. This shows the breakdown on how I am taking mechanical centrifugal energy and turning it into electrical energy.

FIG. 2 shows a section A-A view cut through the center of the main full assembly, which is also shown in FIG. 2. The Section A-A shows an inside view of the assembly and is pointing out various components that which make up the full assembly.

FIG. 3 shows a partial isometric exploded view, which is created to capture the idea that the outer cover is un-assembled and the inside sub assembly is fed inside of the outer tube assembly thus making up the entire self-charging battery assembly.

FIG. 4 shows a sub assembly of the main driving centrifugal force gear to wind the spring. The figure is showing a weighted gear that spins around a shaft. FIG. 4 is also showing a section cut through the main assembly as in FIG. 2. This section cut is added to point out the location of the above mentioned weighted centrifugal gear.

FIG. 5 shows an isometric exploded view of a partial assembly of the entire assembly. The above mention FIG. 5 is created to show the sub assembly of how the weighted main driving centrifugal force gear is assembled into the assembly and how the circuit board assembly and capacitor slide into the inner housing that the weighted gear mounts onto the inner housing.

FIG. 6 shows an isometric view of the gear train assembly 4 which is used to increase torque and wind the main clock spring. FIG. 6 is also showing the above mentioned gear train 4 assembly in a disassembled state for clarity of how the parts are to be assembled. FIG. 6 is also showing a section cut through the main assembly as in FIG. 2. This section cut is added to point out the location of the above mentioned gear train 4 assembly.

FIG. 7 shows an isometric view of the clutch assembly, which is used to Allow the transition to be from the gear train 1 torque clock spring windup gear assembly to the gear train 2, which is to allow the force of the pre wound clock spring to engage the above said gear train 2 which is a speed increasing gear train and is connected to the shaft of a DC motor and is used to spin the shaft of the above said motor thus creating electrical energy. FIG. 7 is also showing a section cut through the main assembly as in FIG. 2. This section cut is added to point out the location of the above mentioned clutch assembly.

FIG. 8 shows an isometric view of the gear train assembly 24 which is used to increase speed and is connected to the shaft of a DC motor through a series of gears. FIG. 8 is also showing the above-mentioned gear train 24 assembly in a manner for clarity of how the parts are to be assembled. FIG. 8 is also showing a section cut through the main assembly as in FIG. 2. This section cut is added to point out the location of the above mentioned gear train 24 assembly.

FIG. 9 shows a partial isometric exploded view of the Gear train 24 and it's surrounding components. FIG. 9 is created to also show how the above mentioned gear train 24 is to be sub assembled into it's armatures. FIG. 9 is also showing the assembly sequence of the switch which is used along with the clutch assembly to transfer power from the clock spring to the gear train 24 to provide mechanical power to the shaft of the DC motor. FIG. 9 is also created to show assembly sequence of the clock spring and clutch sub assembly.

FIG. 10 shows an isometric view of the capacitor and circuit board assembly 10 that is used to transfer electrical energy from the capacitor to the rechargeable battery as will be mentioned in a later step. FIG. 10 is also showing a section cut through the main assembly as in FIG. 2. This section cut is added to point out the location of the Above-mentioned capacitor and circuit board assembly 10.

FIG. 11 shows an isometric view of circuit board assembly 10 and the rechargeable battery, which is to be encased within the main assembly. FIG. 11 also shows circuit board assembly 12 which is used to take electrical energy from the above said rechargeable battery and regulate the flow of the electrical energy from this rechargeable battery and send the regulated electrical energy to the specifications set within the outer battery parameters. FIG. 11 is also showing a section cut through the main assembly as in FIG. 2. This section cut is added to point out the location of the above mentioned rechargeable battery and circuit board assembly 10.

FIG. 12 shows a section cut through the main assembly as in FIG. 2. This section cut is added to point out the location of the Positive (+) wire routing and the Negative (−) wire routing from the Circuit board assembly 12 to the outer battery's Positive (+) and Negative (−) wire routing.

### DETAILED DESCRIPTION OF THE PREFERRED EMBODIMENTS

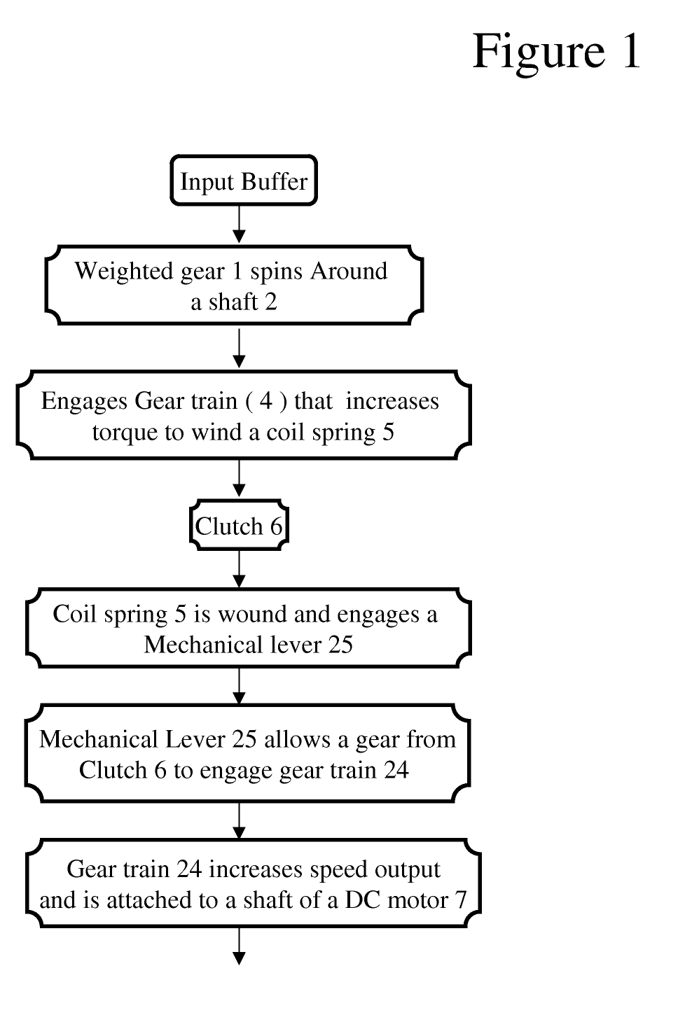

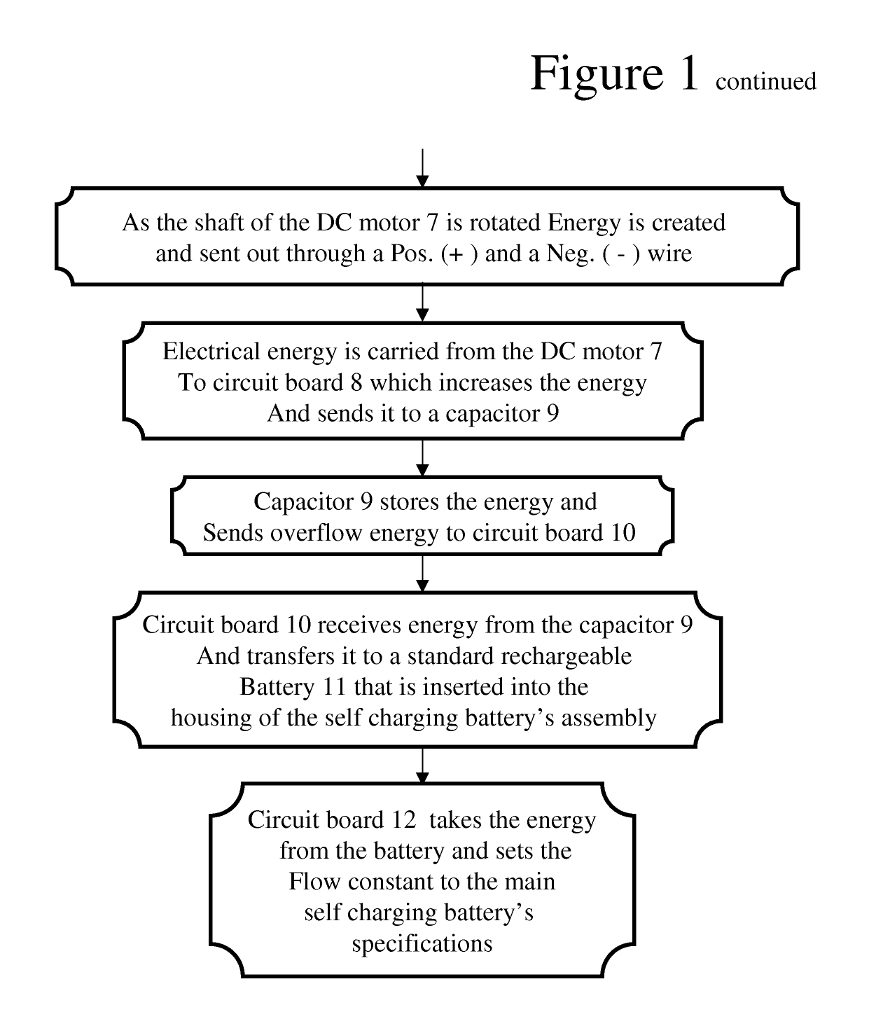

FIG. 1 is a flow chart that shows the entire operation of my present invention. This shows the breakdown on how I am taking mechanical centrifugal energy and turning it into electrical energy. The above mentioned is started by providing an input buffer which is any movement that will force the weighted gear 1 to spin around a shaft 2 and is seated such onto bearings 3 that are located between the weighted gear 1 and the inner base 16 and are located in a racetrack which provide less friction for the weighted gear to freely spin in a 360 degree manner and in either direction. The above mentioned weighted gear 1 has a gear built onto it and is centrally located and is concentrically located also around the shaft 2. As the weighted gear 1 spins around shaft 2 it engages gear train 4 that is a torque increasing gear train. The above-mentioned gear train 4 has a reversing gear built into it's assembly which allows the load to be put onto a coil spring 5 (which will be mentioned later) in the same load direction to wind the coil spring 5. Gear train 4 is connected to a clutch assembly 6 that is concentrically located within the assembly. The clutch assembly 6 is created to allow the force from the gear train 4 to wind a coil spring 5 to provide the drive torque force for a gear train 24 which will be mentioned later. Once the coil spring 5 is pre tensioned to capacity it then engages a switch 25 that is connected to the end of the coil spring 5 and is seated such that the end of the switch 5 is provided as a stopper to a clutch assembly 6 sub component 28 that is part of the clutch assembly 6. The switch 25 is actuated by the force of the coil spring 5 and is then moved out of the way of the above mentioned clutch assembly 6 sub component 28 thus allowing the pre wound force of the coil spring 5 to now engage gear train 24 which is set to increase the speed output through a series of gears that which will be mentioned later. Gear train 24 is connected to a gear 37 within it's assembly that is connected to the shaft of a DC motor 7. The above mentioned gear train 24 is set to increase the output speed in such a manner that the shaft of the DC motor 7 spins a speed rate to allow the DC motor 7 to create electrical energy from it's Positive (+) and Negative (−) terminals. The Electrical energy created from the DC motor 7 is then carried to a circuit board 8 through a Positive (+) and Negative (−) wires. Circuit board 8 then takes the energy from the DC motor 7 and increases that energy through a series of circuits and then sends the above mentioned electrical energy to a capacitor 9 through a Positive (+) and Negative (−) wire that is connected from the above mentioned circuit board 8 to the capacitor 9 which is located under the circuit board 8 and seated inside of the inner base 16 and onto circuit board 10 within the assembly. The capacitor 9 is allowed to reach its full capacity before sending the said electrical energy through the circuits of circuit board 10 which is located under the capacitor 9 and is also seated inside of the inner base 16. The electrical energy is carried from the capacitor 9 and sent to a pre assembled standard rechargeable battery 11 through a series of circuits within circuit board 10 through a Positive (+) and Negative (−) wire that is located underneath circuit board 10 and seated within the assembly thus providing an electrical charge to the rechargeable battery 11. The electrical energy from the rechargeable battery is then carried to a circuit board 12 through a Positive (+) and Negative (−) wire from the rechargeable battery to the circuit board 12. The above-mentioned circuit board 12 is created to manage the flow of the electrical energy to be set to the outer main battery's specifications. The Positive (+) wire is connected from circuit board 12 and routed inside through the main battery's assembly and connected to the main battery's Positive (+) cap 15. The Negative (−) wire is connected from circuit board 12 and is routed within the main battery's assembly and is connected to the main battery's Negative cap 13. This creates the outer battery's circuit.

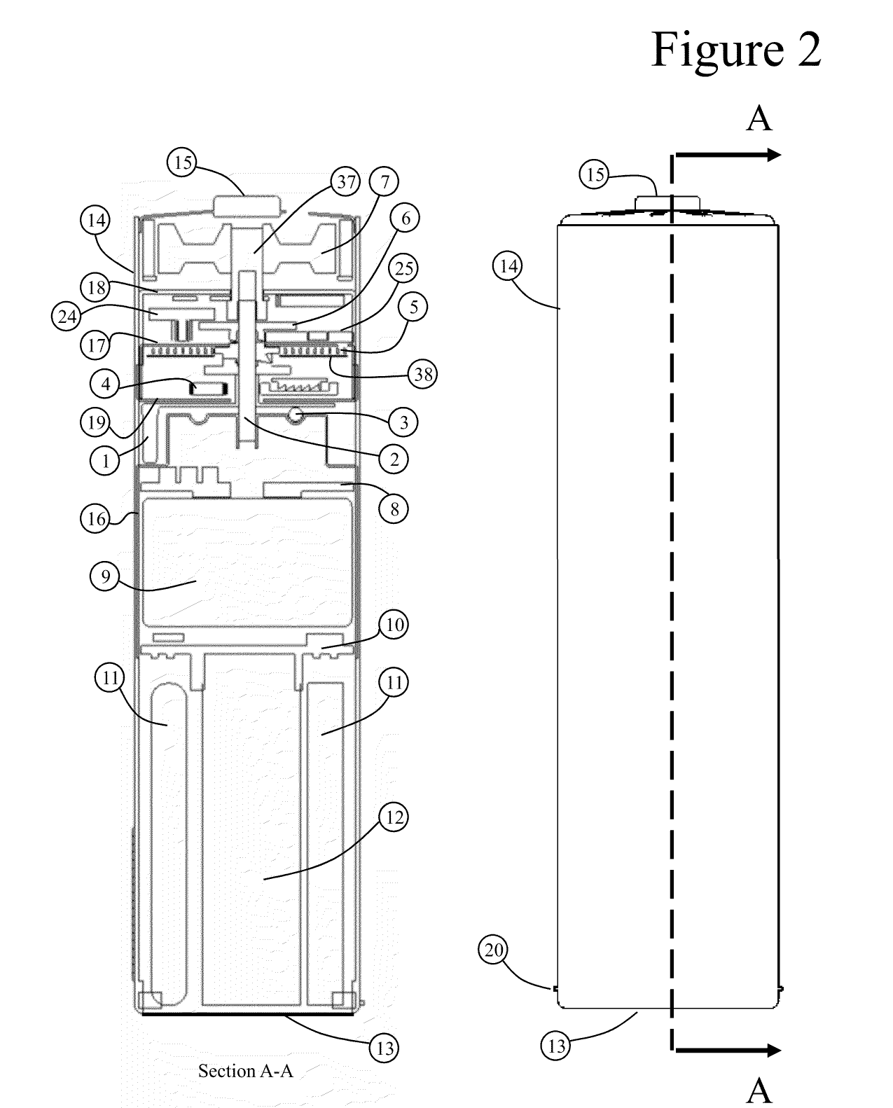

FIG. 2 shows a section A-A view cut through the center of the main full assembly, which is also shown in FIG. 2. The Section A-A shows an inside view of the assembly and is pointing out various components that which make up the full assembly. Component 1 is a weighted gear that spins around a shaft to create centrifugal force to wind a spring. Component 2 is the main shaft, which runs through the center of the assembly and allows the various components of the assembly to remain concentrically located for alignment. Component 3 is a set of bearings that allow the weighted gear to spin around the shaft 2 easier. Component 4 is a gear train assembly that increases the torque output to wind a coil spring. Component 5 is a coil spring used to create the force. Component 6 is a clutch assembly. Component 7 is a DC motor assembly. Component 8 is a circuit board assembly to increase electrical energy. Component 9 is a capacitor used to store electrical energy. Component 10 is another circuit board assembly to take electrical energy from the capacitor and send the above said electrical energy to a rechargeable battery built within the main assembly. Component 11 is a thin standard rechargeable battery built within my self charging battery assembly. Component 12 is a circuit board assembly which is used to take stored electrical energy from the above mentioned component 11 rechargeable battery and regulate that said electrical to match the outer main battery's specification. component 13 is a cap to the main assembly and is located onto the bottom side of the main assembly and is to be designated as the main battery assembly's Negative (−) terminal. Component 14 is a metal tube that is also the main outer encasement of the entire main self charging battery assembly. Component 15 is a cap to the main assembly and is located onto the top side of the main self charging battery assembly and is to be designated as the main battery assembly's Positive (+) terminal. Component 16 is an inner base which is used to seat the shaft 2 and also has a racetrack built within the topside to allow positioning and free movement of the ball bearings 3 and also acts as a protective housing to the circuit board 8, capacitor 9 and circuit board 10 that which are to be housed within the above mentioned inner base 16 which is to be fit within the self charging battery's main assembly tube 14. Component 17 is a lower housing of which is used to seat the shafts of each gear that is a sub component of gear train 24 and also acts as an encasement to the coil spring 5 and is to be seated within the main assembly outer encasement tube 14. Component 18 is an upper housing of which is used to seat the shafts of each gear that is a sub component of gear train 24 and is to be seated within the main assembly outer encasement tube 14. component 19 is a lower housing of which is used to seat the shafts of each gear that is a sub component of gear train 4 and is to be seated within the main assembly outer encasement tube 14. Component 20 is a clip which is used to hold in the bottom cap 13 and thus allows the removal of the bottom cap 13 and to remove and replace the rechargeable battery 11 for the event of recycling thus returning the main self-charging battery assembly to a full rechargeable state. Component 24 is a gear train that is used to increase speed through a series of gears and is connected to a drive gear 37 that is connected to the shaft of a DC motor 7. Component 25 is a switch to be used in conjunction with the coil spring 5 and the clutch assembly 6 and is used to unlock a gear for free spinning to activate the gear train 24.

component 37 is a drive gear that which is connected from a gear train 24 and to the shaft of the dc motor 7. Component 38 is a plate to help bolster the coil spring 5 and is located within the main battery assembly.

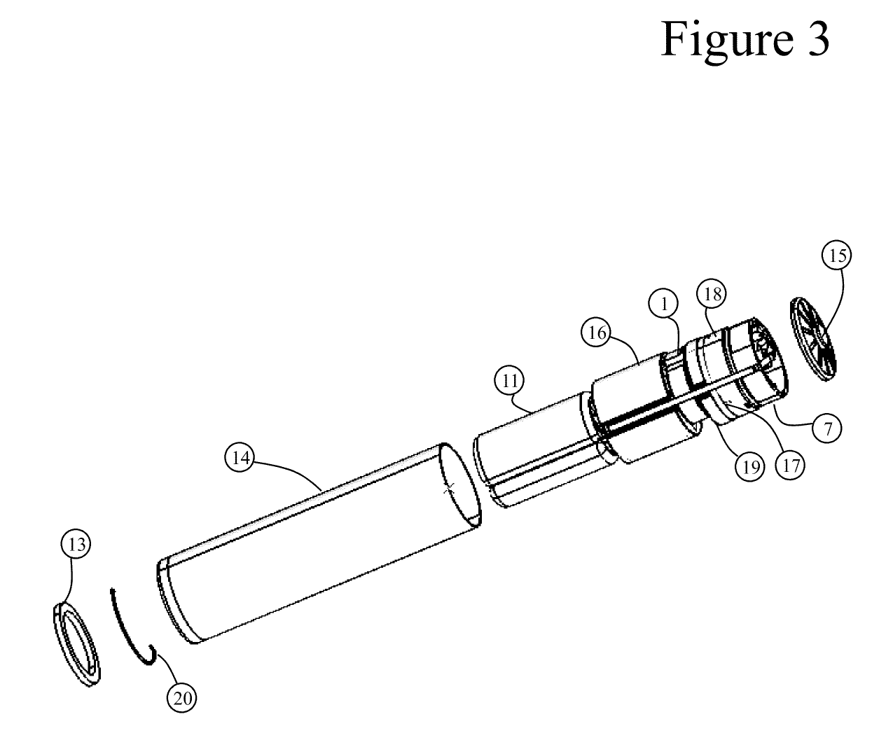

FIG. 3 shows a partial isometric exploded view, which is created to capture the idea that the outer cover is un-assembled and the inside sub assembly is fed inside of the outer tube assembly thus making up the entire self-charging battery assembly. Component 1 is shown and is the weighted gear that which engages the gear train 4 (not shown on FIG. 3), which winds the coil, spring 5 (not shown on FIG. 3). Component 7 is a DC motor used to provide electrical energy by means of turning the shaft of the DC motor such as a dynamo style electrical generator. Component 11 is a standard rechargeable battery to be built into my self-charging battery assembly and is to be housed within such main battery assembly. Component 13 is a cap to the main assembly and is located onto the bottom side of the main assembly and is to be designated as the main battery assembly's Negative (−) terminal Component 14 is a metal tube that is also the main outer encasement of the entire main Self-charging battery assembly. Component 15 is a vented cap to the main assembly and is located onto the top side of the main self charging battery assembly and is to be designated as the main battery assembly's Positive (+) terminal. Component 16 is an inner base which is used to seat the shaft 2 (not shown on FIG. 3) and has a racetrack built within the topside to allow positioning and free movement of the ball bearings 3 (not shown on FIG. 3) and also acts as a protective housing to the circuit board 8 (not shown on FIG. 3), capacitor 9 (not shown on FIG. 3) and circuit board 10 (not shown on FIG. 3) that which are to be housed within the above mention inner base 16 which is to be fit within the self charging battery's main assembly tube 14. Component 17 is a lower housing of which is used to seat the shafts of each gear that is a sub component of gear train 24 (not shown on FIG. 3) and also acts as an encasement to the coil spring 5 (not shown on FIG. 3) and is to be seated within the main assembly outer encasement tube 14. Component 18 is an upper housing of which is used to seat the shafts of each gear that is a sub component of gear train 24 (not shown on FIG. 3) and is to be seated within the main assembly outer encasement tube 14. Component 19 is a lower housing of which is used to seat the shafts of each gear that is a sub component of gear train 4 (not shown on FIG. 3) and is to be seated within the main assembly outer encasement tube 14. Component 20 is a clip which is used to hold in the bottom cap 13 and thus allows the removal of the bottom cap 13 and to remove and replace the rechargeable battery 11 for the event of recycling thus returning the main self-charging battery assembly to a full rechargeable state.

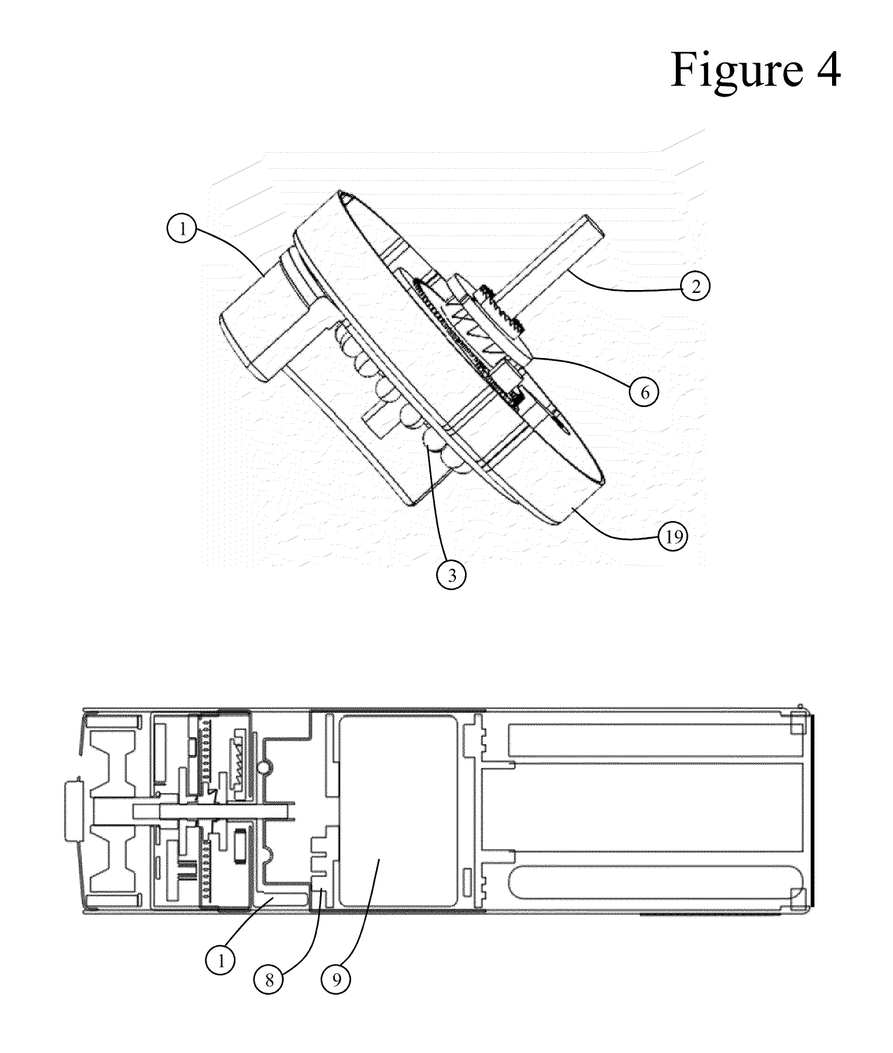

FIG. 4 shows a sub assembly of the main driving centrifugal force gear to wind the spring. The figure is showing a weighted gear that spins around a shaft. FIG. 4 is also showing a section cut through the main assembly as in FIG. 2. This section cut is added to point out the location of the above mentioned weighted centrifugal gear. Component 1 shows the weighted gear which is used to actuate the gear train 4 (not shown in FIG. 4), which then winds the coil spring 5 (not shown in FIG. 4) Component 2 is a shaft, which is used to concentrically hold the weighted gear 1 around and other various gears in place. Component 3 is a set of bearings that allow the weighted gear to spin around the shaft 2 with minimum drag. Component 6 is the clutch assembly and is created to allow the transition of force from the gear train 4 (not shown in FIG. 4) to wind a coil spring 5 (not shown in FIG. 4) to provide the drive torque force for a gear train 24 (not shown in FIG. 4) Component 8 Is a circuit board assembly to increase electrical energy. Component 9 is a capacitor used to store electrical energy. Component 19 is a lower housing of which is used to seat the shafts of each gear that is a sub component of gear train 4 (not shown on FIG. 4) and is to be seated within the main assembly outer encasement tube 14 (not shown on FIG. 4)

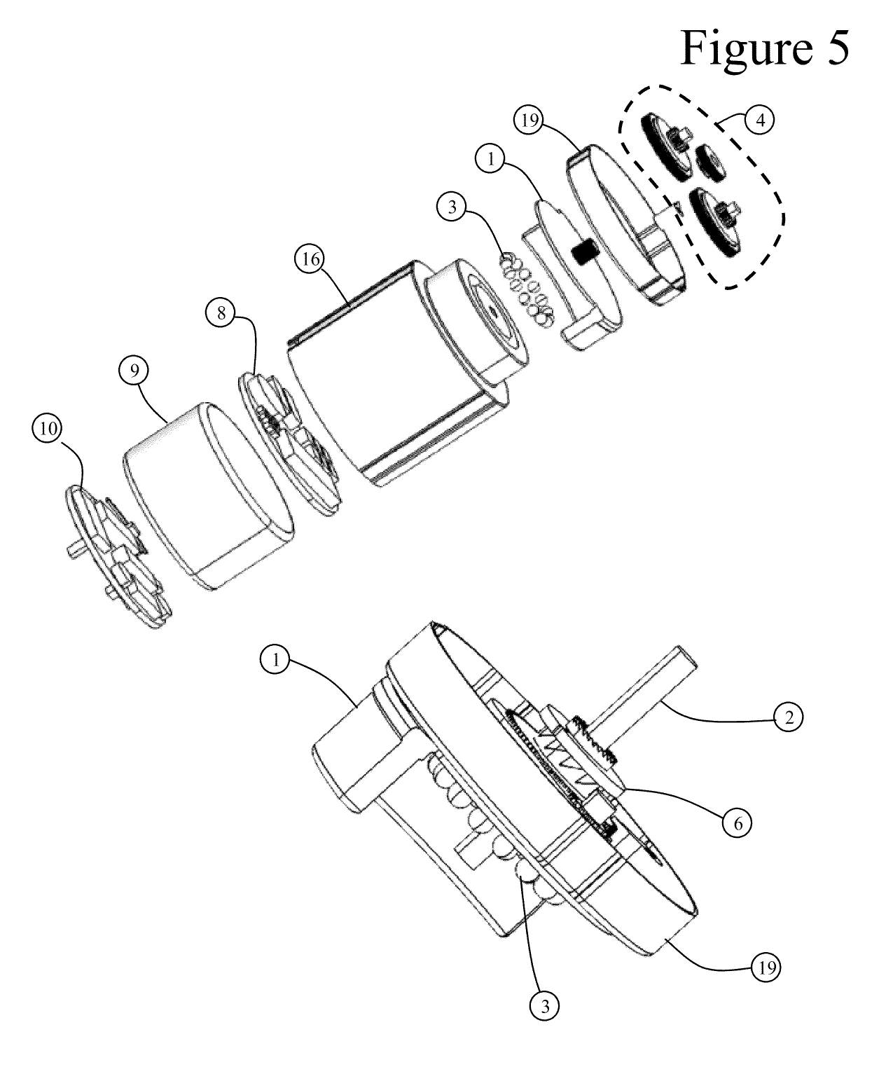

FIG. 5 shows an isometric exploded view of a partial assembly of the entire assembly. The above mention FIG. 5 is created to show the sub assembly of how the weighted main driving centrifugal force gear is assembled into the assembly and how the circuit board assembly and capacitor slide into the inner housing that the weighted gear mounts onto the inner housing. Component 1 shows the weighted gear which is used to actuate the gear train 4 (not shown in FIG. 5), which then winds the coil spring 5 (not shown in FIG. 5) Component 2 is a shaft, which is used to concentrically hold the weighted gear 1 around and other various gears in place. Component 3 is a set of bearings that allow the weighted gear to spin around the shaft 2 with minimum drag. Component 4 is a gear train assembly, which is used to take the mechanical energy from the weighted gear 1 and increase the torque to wind the coil spring 5 (not shown in FIG. 5) and works with the added gear to keep the output direction in the same manner so the weighted gear is allowed to rotate in either direction and still winds the coil spring 5 (not shown in FIG. 5) Component 8 is a circuit board assembly to increase electrical energy. Component 9 is a capacitor used to store electrical energy. Component 10 is a circuit board assembly which is used to transfer electrical energy from the capacitor 9 to the rechargeable battery 11. Component 16 is an inner base which is used to seat the shaft 2 (not shown on FIG. 5) and also has a racetrack built within the topside to allow positioning and free movement of the ball bearings 3 and also acts as a protective housing to the circuit board 8, capacitor 9 and circuit board 10 that which is to be housed within the above mentioned inner base which is to be fit within the self-charging battery's main assembly tube 14 (not shown on FIG. 5). Component 19 is a lower housing of which is used to seat the shafts of each gear that is a sub component of gear train 4 and is to be seated within the main assembly outer encasement tube 14 (not shown on FIG. 5)

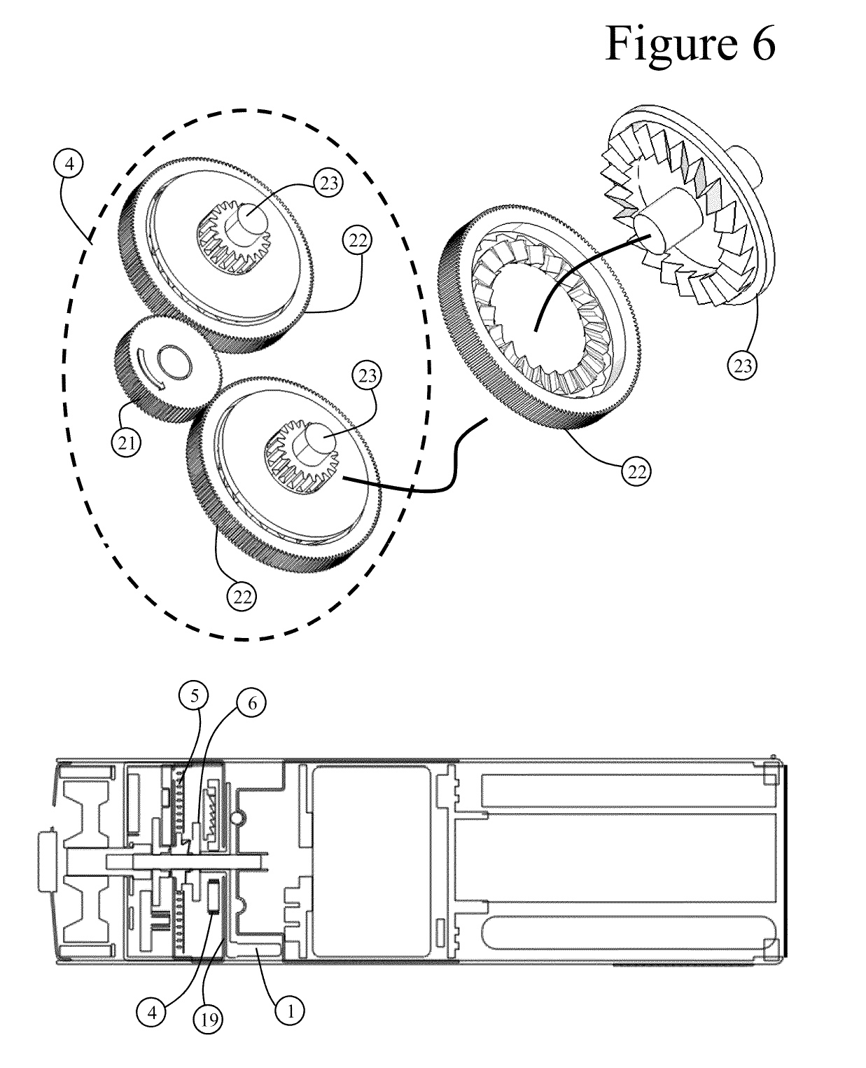

FIG. 6 shows an isometric view of the gear train assembly 4 which is used to increase torque and wind the main clock spring. FIG. 6 is also showing the above mentioned gear train 4 assembly in a disassembled state for clarity of how the parts are to be assembled. FIG. 6 is also showing a section cut through the main assembly as in FIG. 2. This section cut is added to point out the location of the above mentioned gear train 4 assembly. Component 1 shows the weighted gear that is used to actuate the gear train 4, which then winds the coil spring 5. Component 4 is a gear train assembly that increases the torque output to wind a coil spring. Component 21 is a step reversing gear that drives Component 22 and is used to allow the gear component 22 to rotate in a clockwise manner to wind the clock spring in the correct manner. Component 23 is a gear set inside of component 22 gear that is used to keep the rotation of the gear train assembly in a clockwise motion when the weighted gear 1 is moving in either direction and keeps the torque force moving in the clockwise direction therefore always winding the coil spring 5 by means of a ratcheting motion. This gear train assembly 4 works in conjunction with Component 6, which is the clutch.

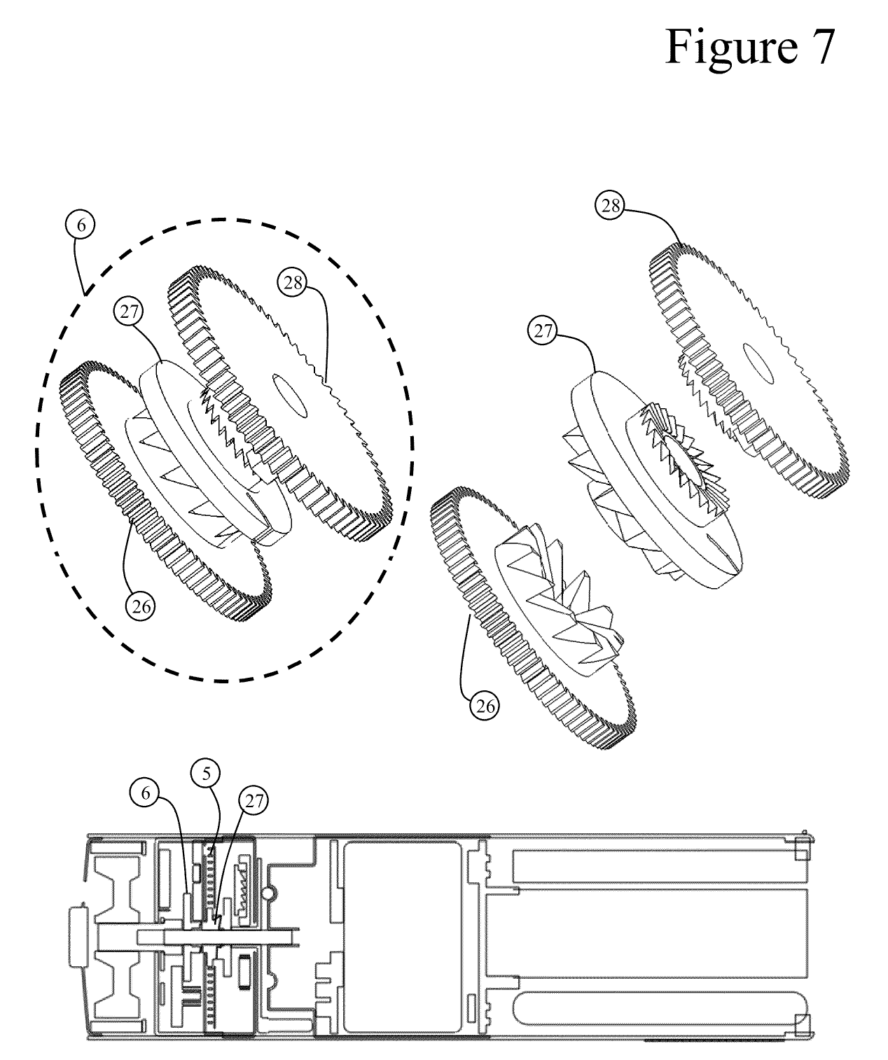

FIG. 7 shows an isometric view of the clutch assembly, which is used to Allow the transition to be from the gear train 1 torque clock spring windup gear assembly to the gear train 2, which is to allow the force of the pre wound clock spring to engage the above said gear train 2 which is a speed increasing gear train and is connected to the shaft of a DC motor and is used to spin the shaft of the above said motor thus creating electrical energy. FIG. 7 is also showing a section cut through the main assembly as in FIG. 2. This section cut is added to point out the location of the above mentioned clutch assembly. Component 6 is the full clutch assembly. Component 26 is a gear which is connected from component 4 gear train assembly and is contacted by component 23 from the above-mentioned gear train 4. The gear on component 23 is considerably smaller than the component 26 gear thus allowing maximum torque. Component 27 is a transitional gear part of the component 6 clutch assembly and is used bolster the end of the component 5 coil spring and has teeth built within itself perpendicular to the gear teeth which are used to allow the transitional gear to provide force to wind the coil spring 5 in it's proper direction and once wound, allows the coil spring 5 to unwind freely by means of a ratcheting manner. Component 28 is a main drive gear which has stopper tabs built onto it's side for a switch activation, which will be discussed later in my claims. Component 28 gear is thus connected to the component 29 gear of component 24 gear train assembly. Component 28 is the powered by the mechanical force of the pre wound component 5 clock spring and is to be the driving force to actuate component 24 gear train assembly.

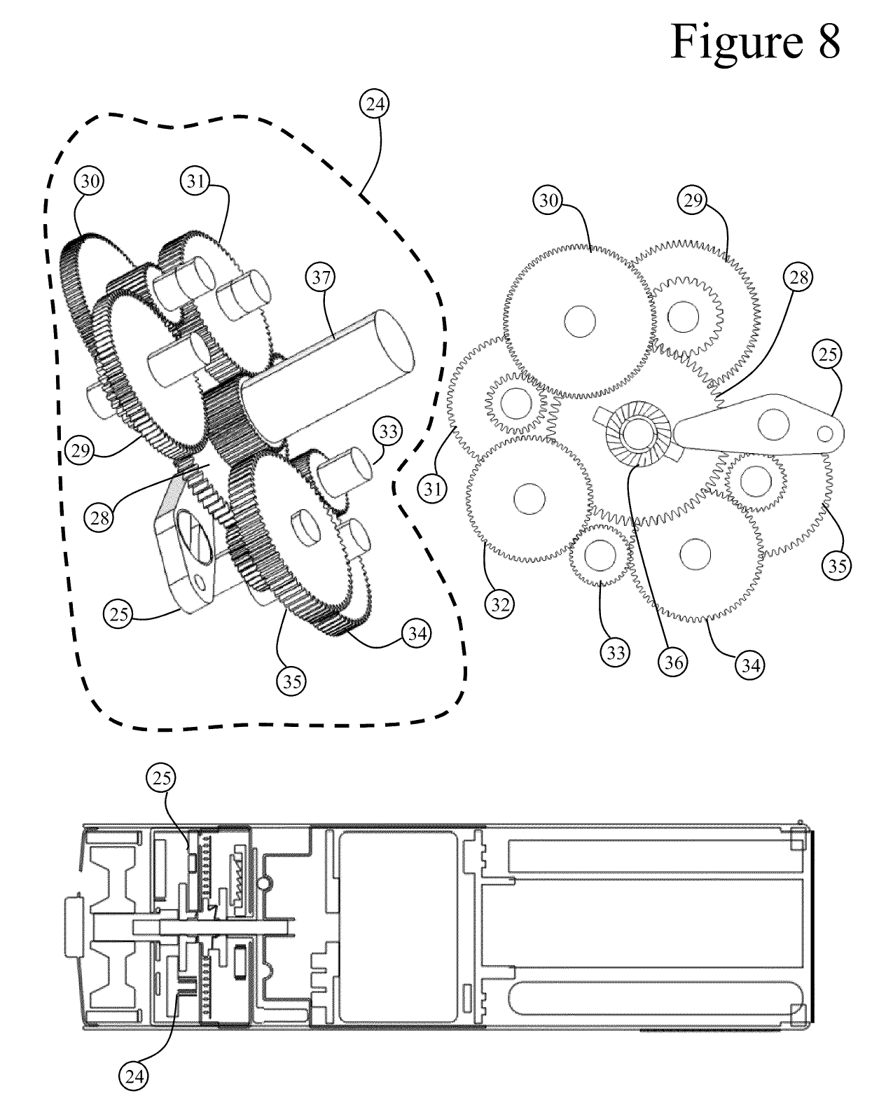

FIG. 8 shows an isometric view of the gear train assembly 24 which is used to increase speed and is connected to the shaft of a DC motor through a series of gears. FIG. 8 is also showing the above-mentioned gear train 24 assembly in a manner for clarity of how the parts are to be assembled. FIG. 8 is also showing a section cut through the main assembly as in FIG. 2. This section cut is added to point out the location of the above mentioned gear train 24 assembly. Component 25 is a stopper switch that is in contact with the stopper tabs, which are a part of component 28 that is a main drive gear. As the component 5 coil spring (not shown in FIG. 8) is in the pre wound state, the end of the coil spring 5 is connected to the component 25 stopper switch thus pulling the switch over and moving the end of the component 25 stopper switch out of the drive path of the stopper tabs on component 28 drive gear and allowing the above mentioned component 28 drive gear to freely spin in a 360 degree manner and allowing the component 28 drive gear to actuate the component 24 gear train. Component 29 is a first contact of the above mention component 28 drive gear and is a double sized gear where the small size gear is in contact with component 28 to increase speed output, while the larger sized gear part of the component 29 is the connected to the smaller sized gear in the part of component 30 which is also a two staged gear is also is used to increase the speed output. Component 30 as mentioned above is a two stage gear to where the larger sized gear is connected to the smaller sized gear of component 31 that is also a two staged gear to increase the speed output. Component 31 is a two staged gear to where the larger gear is connected to the smaller gear of component 32 which is also a two stage gear set for increasing speed output and is connected to component 33 which is a single gear to regulate the spacing of the above mentioned speed drive gears. Component 33 is connected to component 34 which is a single gear that is used to also regulate the proper spacing between component 33 and component 35 which is a two stage speed increasing drive gear. Component 34 drive gear is connected to the smaller sized gear of the above mentioned component 35 two-stage speed drive gear. The larger gear in component 35 two stage drive gear is connected to component 37 which is smaller in size and is also a speed increasing gear set. Component 37 is a drive gear that is connected from the larger sized gear of component 35 to the shaft of the component 7 DC motor (not shown in FIG. 8) and thus provides actuation at a proper rate of speed thus rotating the shaft of the component 7 DC motor (not shown in FIG. 8) and creating electrical energy from the Positive (+) and Negative (−) wires such that as a dynamo style power generation technique.

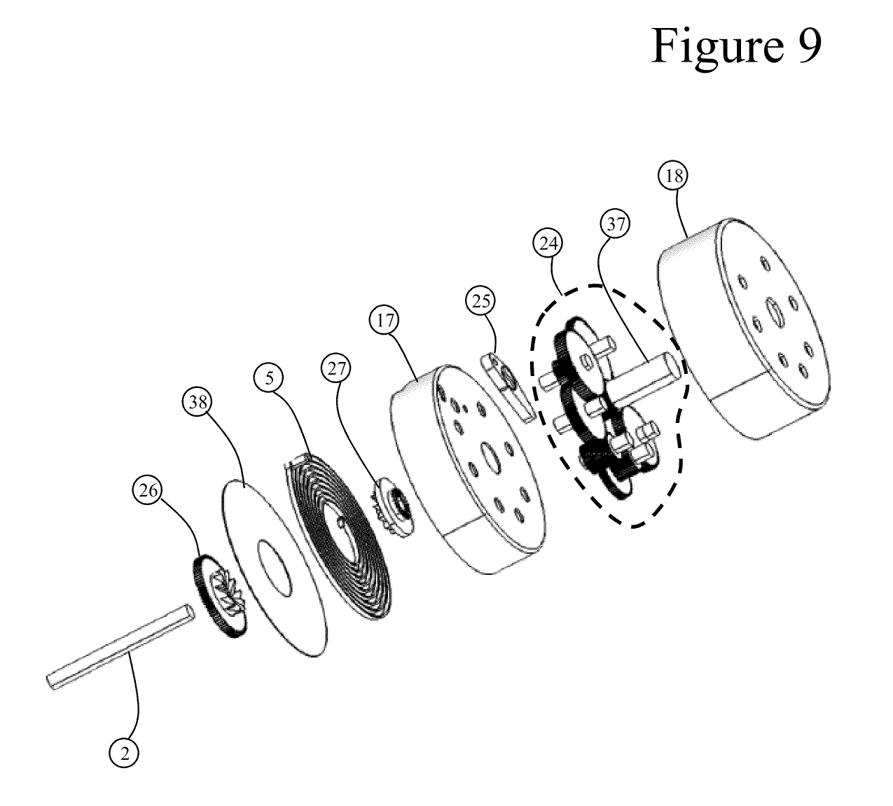

FIG. 9 shows a partial isometric exploded view of the Gear train 24 and it's surrounding components. FIG. 9 is created to also show how the above mentioned gear train 24 is to be sub assembled into it's armatures. FIG. 9 is also showing the assembly sequence of the switch 25 which is used along with the clutch assembly to transfer power from the clock spring to the gear train 24 to provide mechanical power to the shaft of the DC motor. FIG. 9 is also created t Component 18 is an upper housing of which is used to seat the shafts of each gear that is a sub component of gear train 24 (not shown on FIG. 3) and is to be seated within the main assembly outer encasement tube 14.o show the assembly sequence of the clock spring and clutch sub assembly. Component 2 is a shaft that is assembled up through the entire assembly shown in FIG. 9 and is used to concentrically locate the various components of the self charging battery assembly. Component 26 is a gear which is connected from component 4 gear train assembly (not shown in FIG. 9) and is contacted by component 23 from the above-mentioned gear train 4.

The gear on component 23 is considerably smaller than the component 26 gear thus allowing maximum torque. Component 38 is a retainer plate that works to bolster the coil spring 5 for positioning of the coil spring 5 and has a center opening to allow the above mentioned component 26 gear to pass through. Component 5 is a coil spring, which is used to create centrifugal torque force to provide a drive actuation to component 24 gear train assembly which then works to drive the shaft of a DC motor 7 (not shown in FIG. 9) thus transferring mechanical energy to Electrical energy. Component 27 is a transitional gear part of the component 6 clutch assembly and is used bolster the end of the component 5 coil spring and has teeth built within itself perpendicular to the gear teeth which are used to allow the transitional gear to provide force to wind the coil spring 5 in it's proper direction and once wound, allows the coil spring 5 to unwind freely by means of a ratcheting manner. Component 17 is a lower housing of which is used to seat the shafts of each gear that is a sub component of gear train 24 and also acts as an encasement to the coil spring 5 and is to be seated within the main assembly outer encasement tube 14 (not shown in FIG. 9). Component 25 is a stopper switch that is in contact with the stopper tabs, which are a part of component 28 that is a main drive gear. As the component 5 coil spring is in the pre wound state, the end of the coil spring 5 is connected to the component 25 stopper switch thus pulling the switch over and moving the end of the component 25 stopper switch out of the drive path of the stopper tabs on component 28 drive gear and allowing the above mentioned component 28 drive gear to freely spin in a 360 degree manner and allowing the component 28 drive gear to actuate the component 24 gear train. Component 24 is a gear train that is used to increase speed through a series of gears and is connected to a drive gear 37 that is connected to the shaft of a DC motor 7 (not shown in FIG. 9). Component 37 is a drive gear that is connected from the larger sized gear of component 35 (which is a sub component of component 24 gear train assembly) to the shaft of the component 7 DC motor (not shown in FIG. 9) and thus provides actuation at a proper rate of speed thus rotating the shaft of the component 7 DC motor (not shown in FIG. 9) and creating electrical energy from the Positive (+) and Negative (−) wires such that as a dynamo style power generation technique. Component 18 is an upper housing of which is used to seat the shafts of each gear that is a sub component of gear train 24 and is to be seated within the main assembly outer encasement tube 14 (not shown in FIG. 9).

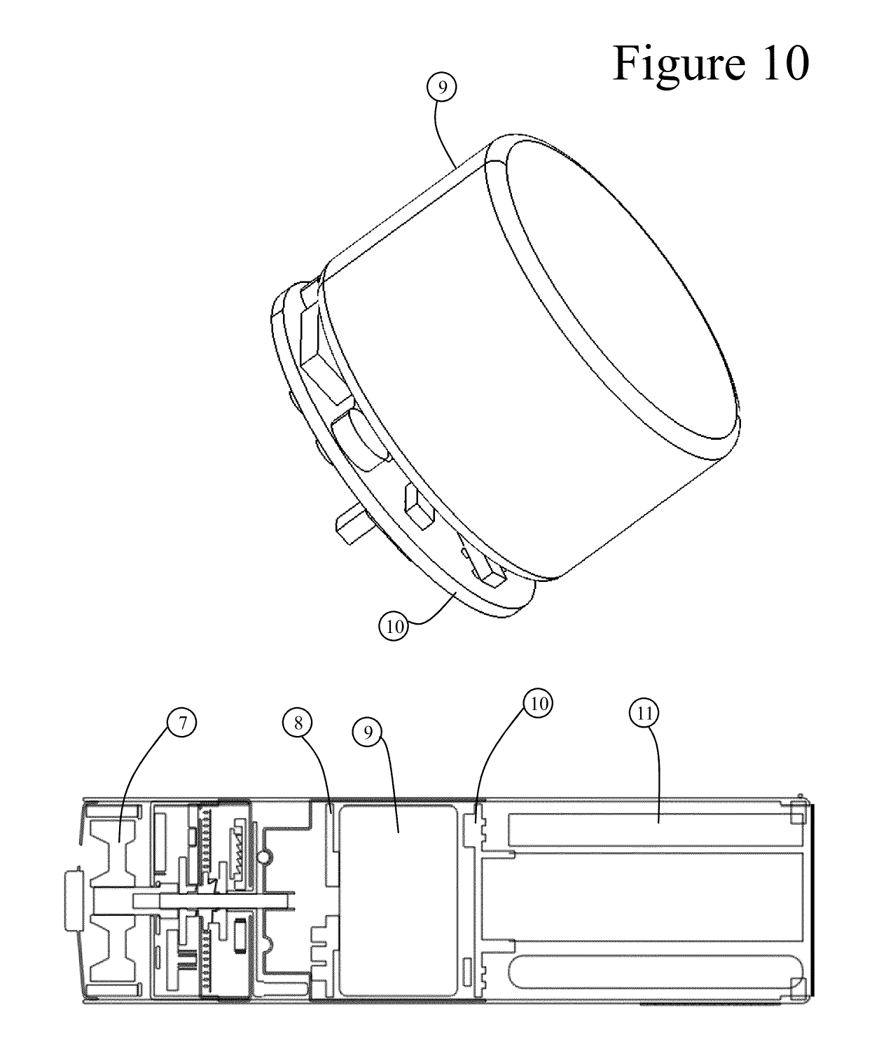

FIG. 10 shows an isometric view of the capacitor and circuit board assembly 2 which is used to transfer electrical energy from the capacitor to the rechargeable battery as will be mentioned in a later step. FIG. 10 is also showing a section cut through the main assembly as in FIG. 2. This section cut is added to point out the location of the Above-mentioned capacitor and circuit board assembly 10. Component 9 is a capacitor used to store electrical energy that is transferred from component 8 which is a circuit board assembly that receives electrical energy from component 7 DC motor. Component 10 is a circuit board assembly which is used to transfer electrical energy from the capacitor 9 to the rechargeable battery 11.

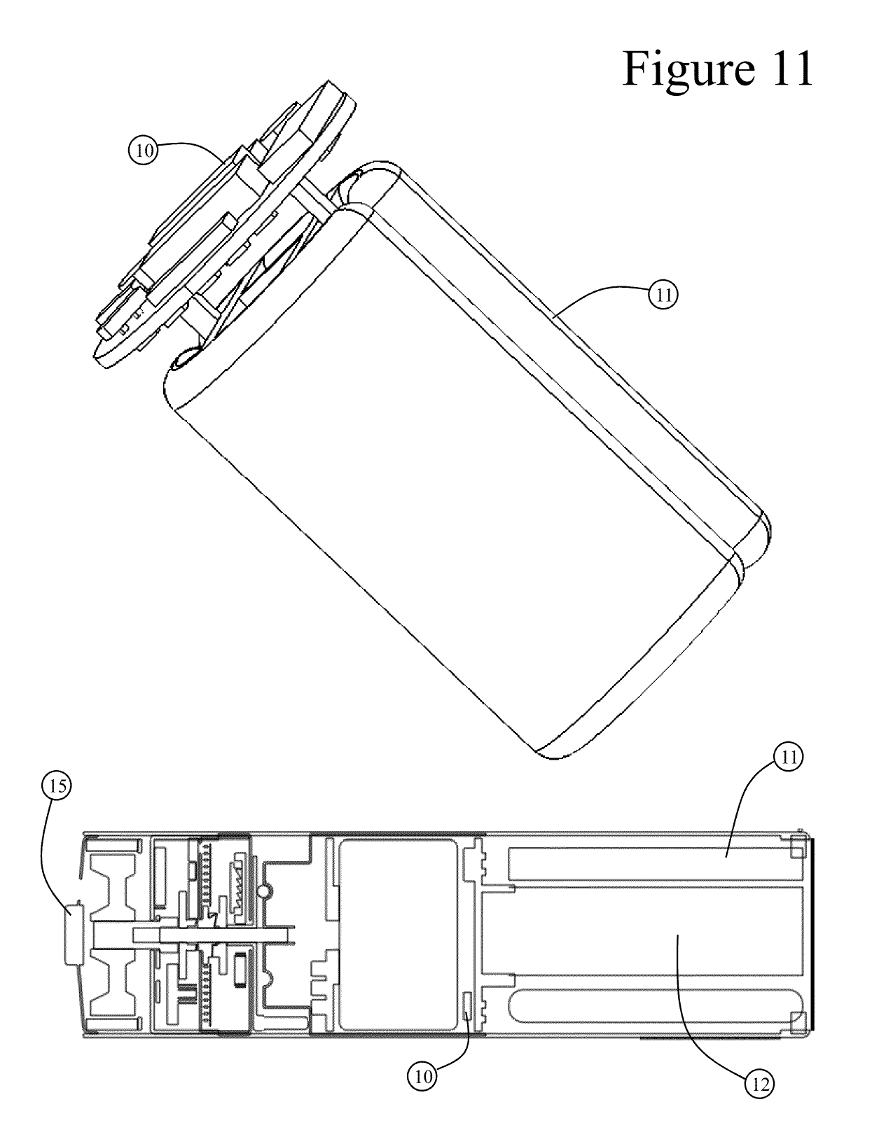

FIG. 11 shows an isometric view of circuit board assembly 10 and the rechargeable battery, which is to be encased within the main assembly. FIG. 11 also shows a circuit board assembly 12 which is used to take electrical energy from the above said rechargeable battery and regulate the flow of the electrical energy from this rechargeable battery and send the regulated electrical energy to the specifications set within the outer battery parameters. FIG. 11 is also showing a section cut through the main assembly as in FIG. 2. This section cut is added to point out the location of the above mentioned rechargeable battery and circuit board assemblies 10 and 12. Component 12 is a circuit board assembly which is used to take stored electrical energy from the above mentioned component 11 rechargeable battery and regulate that said electrical to match the outer main battery's specification.

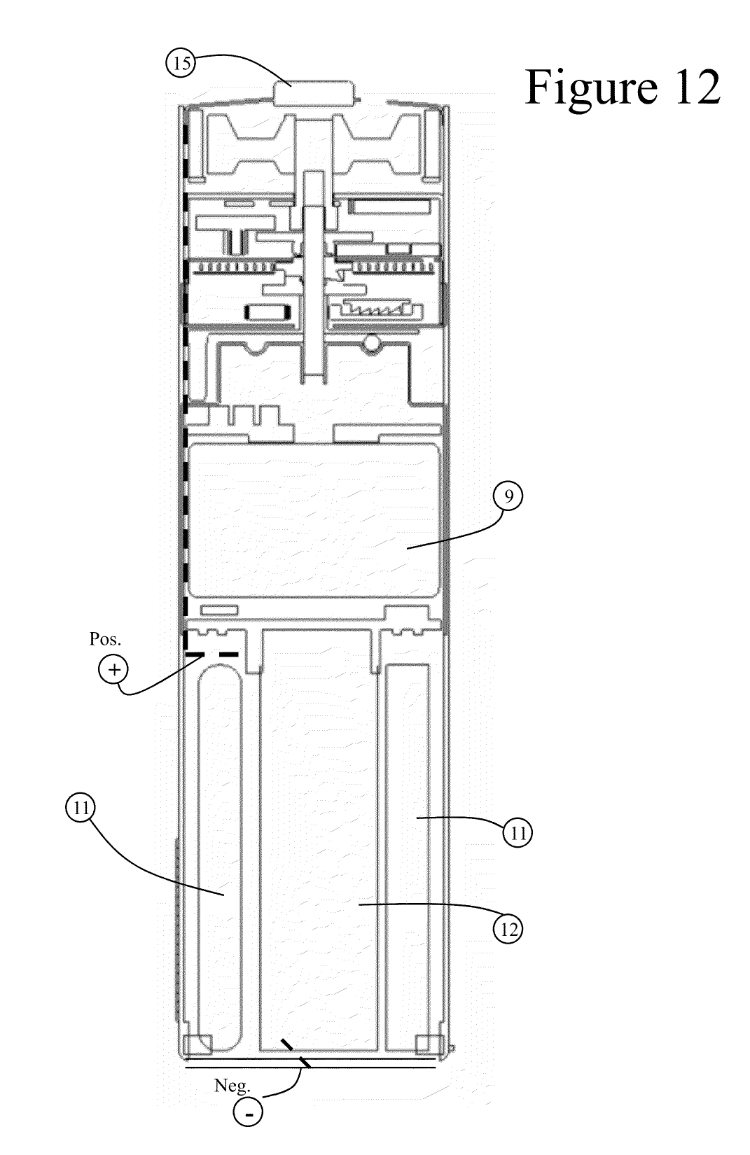

FIG. 12 shows a section cut through the main assembly as in FIG. 2. This section cut is added to point out the location of the Positive (+) wire routing and the Negative (−) wire routing from The Circuit board assembly 12 to the outer battery's Positive (+) and Negative (−) wire routing. This section cut is added to point out the location of the above mentioned rechargeable battery and circuit board assemblies 10 and 12. Component 9 is a capacitor used to store electrical energy that is transferred from component 8 which is a circuit board assembly that receives electrical energy from component 7 DC motor. Component 10 is a circuit board assembly which is used to transfer electrical energy from the capacitor 9 to the rechargeable battery 11. Component 12 is a circuit board assembly that is used to take stored electrical energy from the above mentioned component 11 rechargeable battery and regulate that said electrical to match the outer main battery's specification.

1. What is claimed is a Micro electromechanical generator and method of converting mechanical centrifugal energy into electrical energy.

2. What is claimed is by providing an input buffer which is any movement that will force the weighted gear 1 which is an offset weight and most of the weight is on the outside to create the most effective outer diametrical force that is a precision piece that rotates centrifugally to spin around a shaft 2 and is seated such onto bearings 3 that are located between the weighted gear 1 and the inner base 16 and are located in a racetrack which provide less friction for the weighted gear to freely spin in a 360 degree manner and in either direction and the above mentioned weighted gear 1 is named such that in the center top surface of the part there is a precision gear which protrudes from that surface away from the mass of the part and is centrally located and is concentrically located also around the shaft 2 which is a precision metallic shaft.

3. What is claimed as the weighted gear 1 spins around shaft 2 it engages gear train 4 that is a torque increasing gear train and the above-mentioned gear train 4 has a reversing gear built into it's assembly which allows the load to be put onto a coil spring 5 (which will be mentioned later) in the same load direction to wind the coil spring 5 if weighted gear 1 is rotated in either direction.

4. What is claimed as Gear train 4 is connected to a clutch assembly 6 that is concentrically located within the assembly and the clutch assembly 6 is created to allow the force from the gear train 4 to wind a coil spring 5 without back slippage and to use that force to provide the drive torque force for a second gear train 24 (which will be mentioned later) therefore once the coil spring 5 is pre tensioned to a set capacity it then engages a switch 25 that is connected to the end of the coil spring 5 and is seated such that the end of the switch 5 when in stop state to allow for the coil spring 5 to be wound is provided as a stopper to a clutch assembly 6 sub component 28 that is part of the clutch assembly 6 and the switch 25 is actuated by the force of the coil spring 5 and is then moved out of the way of the above mentioned clutch assembly 6 sub component 28 thus allowing the pre wound force of the coil spring 5 to now engage gear train 24.

5. What is claimed as gear train 24, sub component 29 is a first contact of the above mention component 28 drive gear and is a double sized gear where the small size gear is in contact with component 28 to increase speed output, while the larger sized gear part of the component 29 is then connected to the smaller sized gear in the part of component 30 which is also a two staged gear and is also is used to increase the speed output also component 30 as mentioned above is a two stage gear to where the larger sized gear is connected to the smaller sized gear of component 31 that is also a two staged gear to increase the speed output (component 31 is a two staged gear to where the larger gear is connected to the smaller gear of component 32 which is also a two stage gear set for increasing speed output) and is connected to component 33 which is a single gear to regulate the spacing of the above mentioned speed drive gears and next component 33 is connected to component 34 which is a single gear that is used to also regulate the proper spacing between component 33 and component 35 which is a two stage speed increasing drive gear then component 34 drive gear is connected to the smaller sized gear of the above mentioned component 35 two-stage speed drive gear and the larger gear in component 35 two stage drive gear is connected to component 37 which is smaller in size and is also a speed increasing gear set and component 37 is a drive gear that is connected from the larger sized gear of component 35 to the shaft of the component 7 DC motor.

6. What is claimed as Gear train 24 is connected to a gear 37 within it's assembly and is connected to the shaft of a DC motor 7 at the opposite end of gear 37 and the above mentioned gear train 24 is set to increase the output speed in such a manner that the shaft of the DC motor 7 spins a speed rate to allow the DC motor 7 to create electrical energy from it's Positive (+) and Negative (−) terminals.

7. What is claimed as The electrical energy created from the DC motor 7 is then carried to a circuit board 8 through Positive (+) and Negative (−) wires at this point circuit board 8 then takes the energy from the DC motor 7 and increases that energy through a series of circuits and then sends the above mentioned electrical energy to a capacitor 9 through a Positive (+) and Negative (−) wire that is connected from the above mentioned circuit board 8 and to the capacitor 9 which is located under the circuit board 8 and seated inside of the inner base 16 and onto circuit board 10 within the assembly.

8. What is claimed as the capacitor 9 is allowed to reach its full capacity before sending the said electrical energy through the circuits of circuit board 10 which is located under the capacitor 9 and is also seated inside of the inner base 16 then the electrical energy is carried from the capacitor 9 and sent to a pre assembled standard rechargeable battery 11 through a series of circuits within circuit board 10 through a Positive (+) and Negative (−) wire that is located underneath circuit board 10 and seated within the assembly thus providing an electrical charge to the rechargeable battery 11.

9. What is claimed as the electrical energy from the rechargeable battery is then carried to a circuit board 12 through a Positive (+) and Negative (−) wire from the rechargeable battery to the circuit board 12 and the above-mentioned circuit board 12 is created to manage the flow of the electrical energy to be set to the outer main battery's specifications.

10. What is claimed is the Positive (+) wire is connected from circuit board 12 and routed inside through the main battery's assembly and connected to the main battery's Positive (+) cap 15 and the Negative (−) wire is connected from circuit board 12 and is routed within the main battery's assembly and is connected to the main battery's Negative cap 13 thus creating the outer battery's circuit.

11. What is claimed as a metallic cap that is located on the top of the main assembly of the main assembly and is to be vented for any heat and air to escape the main assembly thus cooling the unit.

12. What is claimed as a battery unit that has an entire micro power generation unit that slides into the main assembly unit and is protected by the component 14 outer tube and is pre assembled prior to being inserted into the component 14 outer tube.

13. What is claimed as a method of recycling a rechargeable battery within the main self charging battery's main assembly by means of removing component 13 bottom cap by removing component 20 locking clip to release component 13 bottom cap and thus removing component 11 rechargeable battery and replacing that battery with a new component 11 rechargeable battery and then re assembling component 13 bottom cap and component 20 locking clip to return the main self charging battery assembly to a new life status.
